(19) United States
(12) Patent Application Publication
(10) Pub. No.: US 2012/0069927 A1
(43) Pub. Date: Mar. 22, 2012

(54) CQI feedback mechanisms for distortion-aware link adaptation toward enhanced multimedia communications

(75) Inventors: Ozgur Oyman, San Jose, CA (US); Jeffrey R. Foerster, Portland, OR (US); Minnie Ho, Los Altos, CA (US)

(73) Assignee: Intel Corporation

(21) Appl. No.: 12/807,933

(22) Filed: Sep. 17, 2010

(51) Int. Cl. H04B 15/00

(52) U.S. Cl. 375/285

(57) ABSTRACT

Link adaptation parameters for encoding of a source are selected to minimize distortion between the source and a reconstructed source induced by transmission of the source over a multiple input multiple output (MIMO) channel. Such distortion-awareness and associated joint source-channel coding ideas to support link adaptation over MIMO channels may affect system architectures for MIMO systems. CQI feedback mechanisms may ensure that these distortion-aware MIMO link adaptation techniques are applicable for downlink channels, under different forms of link adaptation, including MS-controlled vs. BS-controlled link adaptation, long-term vs. dynamic link adaptation, and presence vs. absence of distortion-awareness at the BS, for different kinds of video coding including single-layer compression and layered compression.

### CROSS-REFERENCE TO RELATED APPLICATIONS

The present application claims the benefit of U.S. application Ser. No. 12/655,091, filed Dec. 23, 2009, (docket # P33147), the entire content of which is incorporated by reference herein.

### BACKGROUND

Implementations of the claimed invention generally may relate to wireless communication, and in particular to transmission of downlink information in view of closed loop channel-related feedback.

Wireless communication technology has evolved from a technology offering mainly voice service to a technology that also provides multimedia content. Recent advances in mobile computing and wireless communications enable transmission of rich multimedia content over wireless networks. One such advance is the use of MIMO (Multiple Input Multiple Output) communications in which multiple antennas are used at both the transmitter and the receiver for increasing data throughput without requiring additional bandwidth. Further, while MIMO configurations are usually optimized to maximize data transmission rates, with the increased demand for various different services at the application layer, achieving high reliability in addition to high data transmission rates at the physical layer (PHY) has become ever more important. However, high data rates and high reliability tend to be conflicting design parameters.

Typical wireless communications involve the transmission of a continuous source over a noisy channel. Common examples are speech communications, multimedia communications, mobile TV, mobile video and broadcast streaming. In such communications, the source is encoded and compressed into a finite stream of bits, and the bit stream is then communicated over the noisy channel. Source coding is carried out to convert the continuous source into a finite stream of bits, and channel coding is performed to mitigate the errors in the bit stream introduced by the noisy channel. At the receiver end, a channel decoder recovers the bit stream from its noisy version, and a source decoder reconstructs the multimedia source from the recovered compressed version. During transmission of a multimedia communication, minimizing distortion between the original multimedia source and the reconstructed version at the receiver can provide a better multimedia experience for a user.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 illustrates an exemplary block diagram of a distortion-aware communication system according to some implementations disclosed herein.

FIG. 2 illustrates a block diagram of an exemplary distortion-aware communication system according to some implementations.

FIG. 3 illustrates a flow diagram of an exemplary process for distortion-aware communications according to some implementations.

FIG. 4 illustrates a block diagram of an exemplary system according to some implementations.

FIG. 5 illustrates a flow diagram of an exemplary process for a CQI feedback mechanism for distortion-aware communications in the case of BS-controlled, long-term adaption with no distortion-awareness at the BS.

FIG. 6 illustrates a table of CQI feedback modes and CQI metrics for distortion-aware MIMO link adaptation according to some implementations.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of the claimed invention. However, it will be apparent to those skilled in the art having the benefit of the present disclosure that the various aspects of the invention claimed may be practiced in other examples that depart from these specific details. In certain instances, descriptions of well known devices, circuits, and methods are omitted so as not to obscure the description of the present invention with unnecessary detail.

Some implementations herein provide a distortion-aware MIMO-MCS (Multiple Input Multiple Output Modulation-and-Coding Schemes) and packet size selections toward a communication system that minimizes end-to-end distortion of transmissions. For example, some implementations provide for MIMO link adaptation, preferably in the downlink or downstream direction, and associated channel quality indicator feedback mechanisms for enhancing multimedia communications, and optimizing end-to-end robustness of multimedia content delivery in order to afford a superior user experience. Consequently, some implementations provide channel quality indicator feedback mechanisms for supporting multimedia-optimized adaptive modulation and coding (AMC), MIMO space-time modulation, rate/power adaptation, precoding, antenna selection and packet size selection techniques subject to one or more end-to-end distortion minimization criteria, under different forms of link adaptation, including mobile station (MS)-controlled or base station (BS)-controlled link adaptation and long-term or dynamic link adaptation.

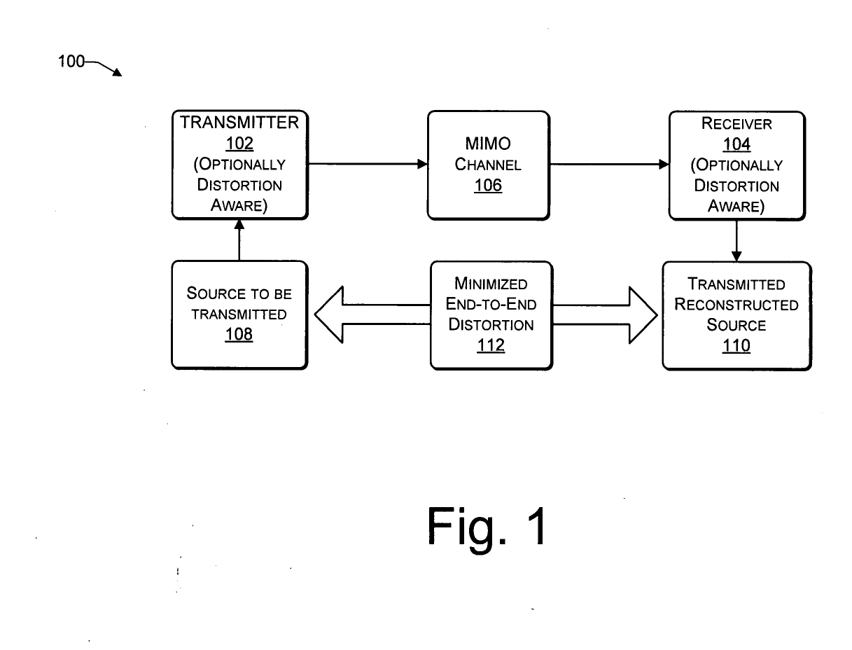

FIG. 1 illustrates an exemplary block diagram of a communication system 100 according to some implementations herein. System 100 includes a transmitter 102 able to communicate with a receiver 104 through a MIMO channel 106. Optionally, transmitter 102 may be distortion-aware. Transmitter 102 is configured to receive a source to be transmitted 108. Transmitter 102, either implicitly or explicitly as explained further below, takes into account distortion minimizing link adaptation parameters during channel encoding, and transmits the source over the MIMO channel to the receiver 104. The receiver 104 is configured to receive the MIMO transmission and reconstruct the transmission to generate a transmitted reconstructed source 110. Because the distortion-aware transmitter 102 takes distortion minimizing parameters into consideration during the encoding stage, the system is able to achieve minimized end-to-end distortion 112 between the source to be transmitted 108 and the transmitted reconstructed source 110, thereby providing improved communications for transmitting multimedia items and the like. As another alternative, the receiver 104 may be distortion-aware (either in addition to transmitter 102 or instead of transmitter 102 if transmitter 102 is not distortion-aware) and provide feedback to the transmitter 102 for enabling the transmitter 102 to be distortion aware. For example, the receiver 104 may determine link adaptation parameters to minimize end-to-end distortion and provide these parameters as feedback to the transmitter 102, which then uses the provided parameters. In this setting, transmitter 102 may also send the rate-distortion characteristics of the source to receiver 104, so that the distortion-aware receiver 104 can utilize this information in determining the link adaptation parameters to achieve the minimized end-to-end distortion 112.

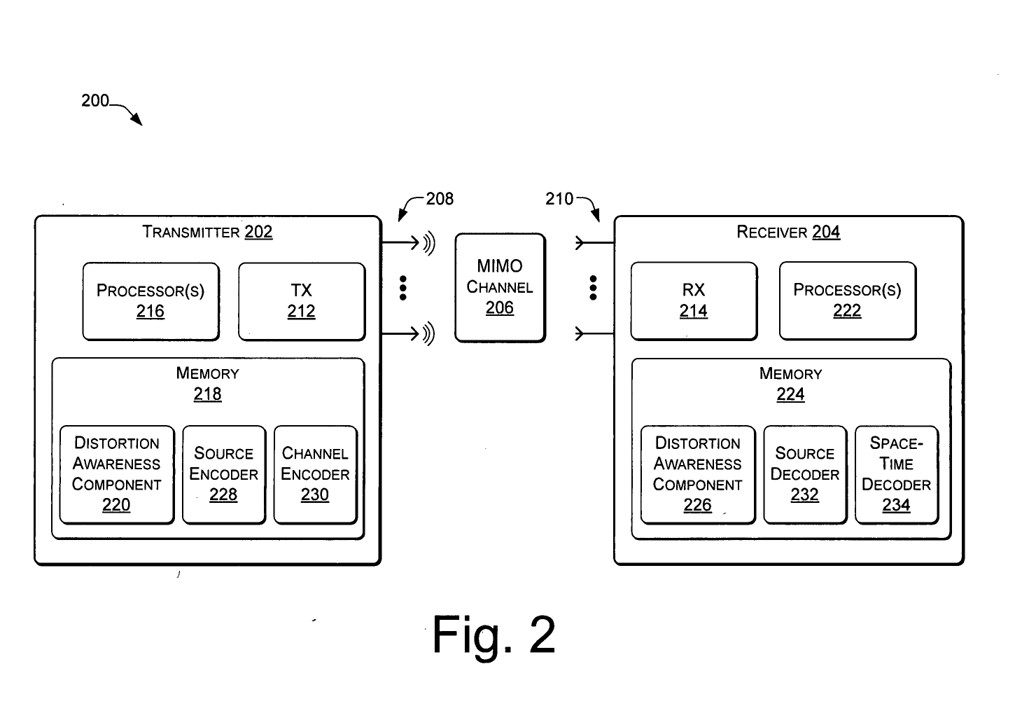

FIG. 2 illustrates an example of a system 200 for minimizing end-to-end distortion using distortion-aware MIMO link adaptation according to some implementations. To this end, the system 200 includes a transmitter 202 configured to communicate wirelessly with a receiver 204 over a MIMO channel 206. Transmitter 202 includes a plurality of transmitter antennas 208 for MIMO communication with a plurality of receiver antennas 210 at receiver 204. Transmitter 202 also includes a transmitter circuit or device 212, such as a radio front end or other wireless transmission mechanism for transmitting signals over the MIMO channel 206. Similarly, receiver 204 may include a receiver circuit or device 214, such as a radio front end or other wireless receiving mechanism for receiving the signals from transmitter 202. In addition, transmitter 202 may include one or more processors 216 coupled to a memory 218 or other processor-readable storage media. For example, memory 218 may contain a distortion awareness component 220 able to be executed by the one or more processors 216 to cause transmitter 202 to carry out the functions described above for minimizing end-to-end distortion. Similarly, receiver 204 may include one or more processors 222 coupled to a memory 224. Memory 224 may contain a distortion awareness component 226 able to be executed by the one or more processors 222 to cause receiver 204 to carry out the functions described above for minimizing end-to-end distortion, such as providing feedback during the closed-loop implementations.

In some implementations, the processor(s) 216, 222 can be a single processing unit or a number of processing units, all of which may include multiple computing units or multiple cores. The processor(s) 216, 222 may be implemented as one or more microprocessors, microcomputers, microcontrollers, digital signal processors, central processing units, state machines, logic circuitries, and/or any devices that manipulate signals based on operational instructions. Among other capabilities, the processors 216, 222 can be configured to fetch and execute processor-executable instructions stored in the memories 218, 224, respectively, or other processor-readable storage media.

The memories 218, 224 can include any processor-readable storage media known in the art including, for example, volatile memory (e.g., RAM) and/or non-volatile memory (e.g., flash, etc.), mass storage devices, such as hard disk drives, solid state drives, removable media, including external drives, removable drives, floppy disks, optical disks, or the like, or any combination thereof. The memories 218, 224 store computer-readable processor-executable program instructions as computer program code that can be executed by the processors 216, 222, respectively, as a particular machine for carrying out the methods and functions described in the implementations herein. Further, memories 218, 224 may also include other program modules stored therein and executable by processor(s) 218, 222, respectively, for carrying out implementations herein, such codecs, or the like. For example, memory 218 may include a source encoder 228 and a channel encoder 230, as discussed above. Similarly, memory 224 may include a source decoder 232 and a space-time decoder 234, as discussed above. Memories 218, 224 may also include data structures, such as stored SNR vectors, lookup tables, MIMO MCS schemes, precoding matrices, packet sizes, and the like (not shown), as discussed above.

Additionally, transmitter 202 and receiver 204 may be implemented in a variety of devices and systems, such as cellular communications systems, Wi-Fi systems, or the like. For example, transmitter 202 might be incorporated in a mobile computing device, such as a cell phone, smart phone, laptop or the like, while receiver 204 might be implemented in a cell tower, wireless access point, a second computing device, or the like, or vice versa. Further, while exemplary system architectures have been described, it will be appreciated that other implementations are not limited to the particular system architectures described herein. For example the techniques and architectures described herein may in incorporated in any of a variety of wireless communication devices, and implementations herein are not limited to any type of communication devices.

In the downstream or downlink case, the generically-named transmitters 102 and/or 202 above may be interchangeably referred to as a base station (BS) or enhanced Node B (eNB) or access point (AP) at the system level herein. In this downlink case, the receivers 104 and/or 204 above may be interchangeably referred to as a mobile station (MS) or user equipment (UE) or station (STA) at the system level herein. Further, the terms BS, eNB, and AP may be conceptually interchanged, depending on which wireless protocol is being used, so a reference to BS herein may also be seen as a reference to either of eNB or AP. Similarly, a reference to MS herein may also be seen as a reference to either of UE or STA.

Thus, most references to BS or MS herein may refer to transmitters and receivers (of downlink multimedia data, because in MS-to-BS upstream channel information feedback, the MS plainly transmits such to the BS which receives it) in the distortion-aware downlink transmission of multimedia data which is of primary interest herein, and which should be assumed for ease of explanation. That said, this invention explicitly contemplates distortion-aware uplink or upstream transmission of multimedia data, in which case the transmitter-to-BS and receiver-to-MS mappings above would be reversed.

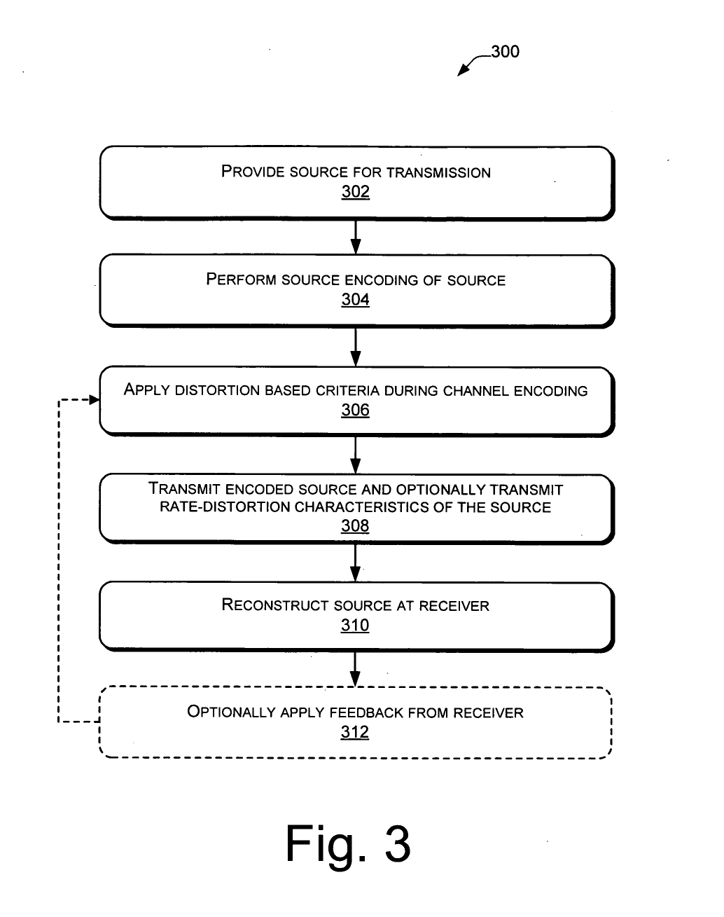

FIG. 3 illustrates a flow diagram of an exemplary process 300 corresponding to the implementation of FIG. 1, 2, or 4. In the flow diagram, the operations are summarized in individual blocks. The operations may be performed in hardware, or as processor-executable instructions (software or firmware) that may be executed by a processor.

At block 302, a source is provided to a transmitter for transmission. For example, the source may be a continuous or finite source, such as a multimedia communication, such as voice over IP (VoIP), speech and audio communications, mobile TV, mobile video services, or the like. Implementations herein may apply to multimedia communications over wireless local area networks (WLANs), wireless personal area networks (WPANs), wireless wide area networks (WWANs) and wireless metropolitan area networks (WMANs). Moreover, implementations may include cellular networks, mobile broadband networks, satellite broadcasting systems and terrestrial broadcasting systems. For example, implementations can be used in 802.11-based LANs, 802.15-based PANs and 802.16-based WANs where MIMO technologies have been adopted and it is desirable to reliably communicate multimedia content (e.g., the IEEE 802.11 standard, IEEE std., 802.11-2009, published Oct. 39, 2009, or future implementations thereof; the IEEE 802.15 standard, IEEE std., 802.15-2006, published September 2006, or future implementations thereof; and the IEEE 802.16 standard, IEEE std., 802.16-2009, published 2009, or future implementations thereof). Implementations can also be used for MIMO in 3G networks, 4G networks, cellular networks, WWANs, 3GPP networks, LTE networks, LTE-Advanced networks, and Mobile TV, and the like. Further, while several specific standards have been set forth herein as examples of suitable applications, implementations herein are not limited to any particular standard or protocol.

At block 304, source coding is carried out by the transmitter to convert the continuous source into a finite stream of bits. At block 306, channel encoding is carried out by the transmitter to mitigate the errors in the bit stream that will be induced by the channel, while incorporating distortion-minimizing parameters during the encoding.

At block 308, the encoded source is transmitted to the receiver over the MIMO channel. Along with the encoded source, the rate-distortion characteristics of the source may optionally be transmitted over the MIMO channel, so that this information may be used by the receiver toward distortion-aware link adaptation.

At block 310, the receiver receives the transmission from the transmitter and decodes the transmission to reconstruct the source. At block 312, optionally, the receiver can provide feedback to the transmitter to provide the transmitter with the distortion-minimizing parameters. When the transmitter receives the feedback, the newly received distortion minimizing parameters can be applied to the source and channel encoding.

As source and channel coding operations are performed at different communication layers, many conventional communication systems implement the source coding entirely separately from the channel coding. That is, source coding may be performed without taking into account the channel behavior and channel coding may be performed without considering the nature of the source. In general, multimedia wireless communication involves transmitting analog sources over fading channels while satisfying end-to-end distortion and delay requirements of the application. For example, delay-limitedness accounts for the presence of stringent latency and buffer constraints. Accordingly, separation of source and channel coding may not be optimal, such as when the channel state information (CSI) is not available at the transmitters or when finite coding block lengths are used due to practical system limitations.

Some implementations herein adopt a joint source-channel coding technique for providing MIMO link adaptation. In the joint source-channel coding according to implementations herein, the source compression and channel coding are performed together, such that the end-to-end distortion for wireless multimedia communication can be minimized by accounting for the impact of both quantization errors (due to lossy compression) and channel-induced errors (due to fading and noise).

Furthermore, a major performance-enhancing technology in today's wireless networks is multiple-input multiple-output (MIMO) wireless communication, which uses multiple antennas at both ends of a point-to-point wireless link. The use of MIMO systems can improve spectral efficiency, link reliability and power efficiency through spatial multiplexing gain, diversity gain and array gain, respectively.

Two practical techniques for space-time modulation in MIMO systems are transmit diversity and spatial multiplexing. MIMO diversity refers to a family of techniques (e.g., space-time coding (STC)) that attempt to spread information across transmit antennas to enable robust transmission and substantial reliability and coverage improvement in the presence of fading. Spatial multiplexing (SM), on the other hand, refers to a form of spatial modulation that achieves high data rates by dividing the incoming data into multiple substreams and transmitting each substream on a different antenna, enabling transmission rate growth dependent, at least in part, upon the number of transmit and receive antennas. A receiver removes the mixing effect of the channel and demultiplexes the symbol stream. A MIMO system can benefit from both MIMO diversity and MIMO SM. As a general rule, at low signal-to-noise ratios (SNRs), it is preferable to use MIMO diversity techniques and at high SNRs it is preferable to use MIMO SM. Adaptive switching between MIMO diversity and MIMO SM based on the knowledge of the long-term and/or short-term channel fluctuations at the transmitter extracts the highest possible gains from MIMO techniques in terms of spectral efficiency and reliability. Apart from adaptive switching between MIMO diversity and MIMO spatial multiplexing, MIMO link adaptation techniques also include MIMO precoding and MIMO antenna selection.

The inventors herein have determined that there is a tradeoff between resolution at the source encoder and robustness at the channel encoder. Accordingly, limiting source distortion and associated quantization errors uses a high-rate source code, for which the multiple antennas of the MIMO channel are used mainly for multiplexing. Alternatively, the source can be encoded at a lower rate with more distortion, and then the channel error probability and associated packet error rate (PER) can be reduced through increased diversity. Consequently, some distortion-aware MIMO link adaptation implementations provided herein take this tradeoff into consideration toward optimizing end-to-end multimedia communications over MIMO wireless networks.

For example, in an implementation of a point-to-point single-user MIMO communication system with a number of Mₜ transmit antennas and a number Mᵣ receive antennas over a coding block length T, the Mᵣ×T received signal vector is given by the following formula:

y=HQs+n

where H is the Mᵣ×Mₜ complex random channel matrix representing the MIMO link (which remains fixed over the entire coding block length T), s is the M×T transmitted space-time block codeword, Q is the Mₜ×M linear precoding matrix (M≦Mₜ is a precoding design parameter) such that trace(Q*Q′)=1 (where Q′ is the Hermitian of Q) and n is the Mᵣ×T additive white Gaussian noise (AWGN) noise vector where each entry has zero mean and variance σ² . The average received signal-to-noise ratio (SNR) for the MIMO link is given by SNR=E└|s|²┘/σ².

The space-time block codeword s incorporates MIMO link adaptation and the associated selection of the MIMO modulation-and-coding schemes (MIMO-MCS), which includes (a) selection of the modulation order, (b) selection of the forward error correction (FEC) type and coding rate, and (c) determination of which space-time modulation techniques will be used. Options include spatial multiplexing (SM), space-time coding (STC), orthogonal space-time block coding (OSTBC), and the like.

Furthermore, the selection of the precoding matrix Q , includes (a) beamforming to convert a MIMO channel into an equivalent single-input single-output (SISO) channel, (b) precoded spatial multiplexing, (c) precoded OSTBC, (d) transmit power allocation and covariance optimization, and (e) transmit antenna selection techniques where M out of Mₜ transmit antennas are selected for transmission.

In the presence of dynamic channel variations due to fading, along with the uncertainty on the actual channel state information (CSI) at the transmitter (due to reasons such as high mobility, noise on the feedback channel and availability of a limited number of CSI feedback bits), there is uncertainty on the achievable rates at the transmitter, and hence, the packet transmitted may be corrupted, leading to packet errors if the transmitted rate exceeds the instantaneous channel capacity determined by the channel realization H. Moreover, AWGN noise also may cause packet errors despite the use of powerful channel coding. Thus, according to some implementations herein, transmissions over the MIMO channel may be associated with a packet error rate (PER), which is impacted by the average received SNR, instantaneous channel realization H, MIMO-MCS scheme and precoding matrix Q.

Typically, MIMO link adaptation aims to maximize the link throughput, goodput or spectral efficiency, which is achieved when the selected MIMO MCS transmission mode provides the highest spectral efficiency based on the channel conditions. Furthermore, packet sizes, i.e., the total number of information bits carried in a given transmission packet, may also be adapted based on the channel conditions. With large packet sizes, it may be possible to send more information bits over the channel in a given packet transmission, but in such settings more packet errors are likely to be encountered compared to transmissions with smaller packet sizes. Consequently, given channel state information, it is possible to predict the packet error rate of all available MIMO MCS modes and packet sizes and choose the MIMO MCS mode and packet size which offers the highest spectral efficiency. Therefore, MIMO link adaptation typically aims to maximize goodput (also known as throughput) given by the following formula:

goodput=\tilde{R}*(1−PER)

such that

$$( MIMO\_MCP , P\_SIZE , Q ) = arg {max}_{MIMO\_MCS , P\_SIZE , Q} \tilde{R} * ( 1 - PER ) ,$$

where \tilde{R} is the space-time transmission rate at the channel coder determined by the selected MIMO-MCS scheme (including FEC type and code rate, modulation order, MIMO space-time modulation scheme), P_SIZE is the packet size, and PER is the packet error rate (PER) determined by the average or long-term received signal-to-interference and noise ratio (SINR), instantaneous or statistical knowledge of the short-term SINR over the MIMO channel, selected MIMO MCS, selected packet size and selected precoding matrix Q.

Instead of attempting to maximize goodput, implementations herein provide a MIMO link adaptation technique for minimizing an expected value of end-to-end distortion by choosing the MIMO MCS, packet size, and precoding matrix Q using the following distortion-based criterion:

$$( {MIMO\_MCS}_{SELECTED} , {P\_SIZE}_{SELECTED} , {Q}_{SELECTED} ) = arg {min}_{MIMO\_MCD , P\_SIZE , Q} {D}_{ave} ( MIMO\_MCS ,$$

where Dₐᵥₑ(MIMO₁₃ MCS,P₁₃ SIZE,Q) represents the average end-to-end distortion for a given MIMO MCS, packet size, and precoding matrix Q. In other words, the selection of MIMO MCS, packet size, precoding matrix Q and MIMO space-time modulation mode (e.g., MIMO diversity or MIMO SM) for the multimedia transmission is decided according to implementations herein so that the resulting end-to-end distortion Dₐᵥₑ(MIMO_MCS,P_SIZE, Q) is minimized.

For the MIMO diversity mode (e.g., MIMO STC, MIMO OTSBC, etc.) as well as single-input single-output (SISO) systems, the average end-to-end distortion at data rate R is given by formula (1); as follows:

Dₐᵥₑ(MIMO_MCS_DIV,P_SIZE,Q)=D(b*R)*(1−PER)+Dₘₐₓ*PER (1)

For the MIMO SM mode with vertical encoding, where a total of N spatial streams are sent simultaneously over the MIMO link using a single space-time-frequency encoder for all N spatial streams, with each spatial stream sent at data rate R, the average end-to-end distortion is given by formula (2), as follows:

Dₐᵥₑ(MIMO_MCS_SM,P_SIZE,Q)=D(N*b*R)*(1−PER)+Dₘₐₓ*PER (2)

In the case of a MIMO vertical encoding architecture with a linear receiver (e.g., zero-forcing (ZF) or minimum mean square-error (MMSE) receiver) followed by a single space-time-frequency decoder, the packet error rate (PER) is dictated by the quantity SINRₘᵢₙ=minₙSINRₙ, such that SINRₙ is the signal-to-interference-and-noise ratio (SINR) corresponding to the n -th multiplexed MIMO spatial stream (n=1, . . . , N).

For the MIMO SM mode with horizontal encoding, where a total of N spatial streams are sent simultaneously over the MIMO link using a separate time-frequency encoder that is associated with each of the N spatial streams, with each spatial stream sent at data rate R , the average end-to-end distortion is given by formula (3), as follows:

$${D}_{ave} ( MIMO\_MCS \_SM , P\_SIZE , Q ) = {\sum }_{n = 0}^{N} D ( n * b * R ) ( {\sum }_{{K}_{n}} {\prod }_{k : {b}_{k} = 1} ( 1 - {PER}_{k} ) {\prod }_{l : {b}_{l} = 0} {PER}_{l} ) \qquad ( 3 )$$

where PERₙ is the packet error rate for the n-th multiplexed MIMO spatial stream (n=1, . . . , N), and for {bₙ∈{0,1}}^{N}ₙ₌₁, then

$${K}_{n} = \{ ( {b}_{1} , … , {b}_{N} ) \text{:} {\sum }_{k = 1}^{N} {b}_{k} = n \} ,$$

after observing that, for the MIMO horizontal encoding architecture, each of the N spatial streams is encoded and decoded independently.

In a slow-fading environment, a burst of error would significantly degrade error performance and thus negatively impact the reliable decoding of the received signal. If the system can tolerate a certain delay, retransmitting the signal using Automatic repeat request (ARQ) protocols would help to enhance communication reliability. The main objective of an ARQ protocol is to prevent, for each link, the loss of frames due to transmission errors. Frame errors are examined at the receiving end by an error detection (usually cyclic redundancy check (CRC)) code. If a frame passes the CRC, the receiving end sends an acknowledgement (ACK) of successful transmission to the receiver. If a frame does not pass CRC and the receiver node detects errors in the received frame, it sends a negative acknowledgement (NACK), requesting retransmission. The request is repeated until the decoder detects an error-free transmission. User data and CRC bits may be additionally protected by an error correcting code which increases the probability of successful transmission. In Hybrid ARQ (HARQ) protocols, error detection and correction are combined in order to obtain better reliability and throughput. Distortion-aware link adaptation techniques may be designed to accommodate ARQ or HARQ based retransmission mechanisms. In particular, for unicast video transmission, it is important to account for the role of ARQ and HARQ in the distortion-aware link adaptation design, while for multicast and broadcast video transmissions, ARQ and HARQ capabilities are often not used and therefore distortion-aware link adaptation should be performed without ARQ and HARQ. For instance, in the MIMO diversity mode (e.g., MIMO STC, MIMO OTSBC, etc.) as well as single-input single-output (SISO) systems, the average end-to-end distortion at data rate R is given by formula (1), can be revised as follows:

$${D}_{ave} ( MIMO\_MCS \_DIV , P\_SIZE , Q ) = D ( bR ) ( 1 - {PER}_{1} ) + D ( bR ) {PER}_{1} ( 1 - {PER}_{2} ) + … + D ( bR ) {\prod }_{j = 1}^{M - 1} {PER}_{j} ( 1 - {PER}_{M} ) + {D}_{max} {\prod }_{j = 1}^{M} {PER}_{j}$$

where PERⱼ is the probability of packet decoding error after the j-th transmission, and M is the maximum number of allowed transmissions. The corresponding average goodput in the presence of the ARQ mechanism is given by

$$goodput = R ( 1 - {PER}_{1} ) + ( R / 2 ) {Per}_{1} ( 1 - {PER}_{2} ) + … + ( R / M ) {\prod }_{j = 1}^{M - 1} {PER}_{j} ( 1 - {PER}_{M} )$$

The implementations herein and associated distortion-aware link adaptation techniques are also applicable in the context of layered video coding, an example of which is the compression scheme defined by the standard H.264 scalable video coding (SVC). In this context, the video sequence is encoded to generate a base layer and several enhancement layers. For the continuity of video playback, it is enough to receive the base layers, whereas the enhancement layers are only used to increase the video quality. Hence, the decoding of the enhancement layers is not required to recover the video stream and they may be dropped if the link conditions are poor and throughput is low. In case of layered video coding such as SVC, the MIMO link adaptation technique to minimize an expected value of end-to-end distortion chooses the MIMO MCS, packet size, and precoding matrix Q for each transmitted layer using the following distortion-based criterion:

$${( {MIMO\_MCS}_{SELECTED}^{( l )} , {P\_SIZE}_{SELECTED}^{( l )} , {Q}_{SELECTED}^{( l )} )}_{l = 1}^{L} = arg {min}_{MIMO\_MCS , P\_SIZE , Q} {D}_{ave} ( {( {MIMO\_MCS}^{( l )} , {P\_SIZE}^{( l )} , {Q}^{( l )} )}_{l = 1}^{L} )$$

where L is the total number of SVC layers, indexed by l=1, . . . , L with l=1 representing the base layer and l=2, . . . , L representing the L−1 enhancement layers, MIMO_MCS^{(l)}, P_SIZE^{(l)}, Q^{(l)} represent the MIMO MCS, packet size and precoding matrix for the l-th video layer respectively, and we can write

$${D}_{ave} ( {( {MIMO\_MCS}^{( l )} , {P\_SIZE}^{( l )} , {Q}^{( l )} )}_{l = 1}^{L} = D ( b {\sum }_{l = 1}^{L} {R}_{l} ) {\prod }_{l = 1}^{L} 1 - {PER}^{( l )} + {\sum }_{l = 2}^{L} D ( b {\sum }_{k = 1}^{l - 1} {R}_{k} ) {\prod }_{k = 1}^{l - 1} ( 1 - {PER}^{( k )} ) {PER}^{( l )} + {D}_{max} {PER}^{( 1 )}$$

where Rₗ is the data rate for the l-th video layer and PER^{(l)} is the packet error rate for the l-th video layer.

In the above equations, D(b*R) represents a distortion-rate function for a multimedia source, i.e., the distortion that the source incurs after reconstruction at the decoder (e.g., due to quantization errors associated with lossy compression by the multimedia codec) as a function of the data rate R determined by the selected MIMO MCS, Dₘₐₓ is the maximum possible distortion experienced when the source reconstruction at the decoder is hindered by packet losses and transmission failures, given by Dₘₐₓ=D(R=0), and b is a fixed scalar normalization term representing the ratio between the source code rate and channel code rate to account for the rate matching between the multimedia codec and the channel coder. For example, some implementations assume delay-limited multimedia traffic which cannot be buffered due to tight latency constraints. The distortion-rate function D(b*R) is a decreasing function of the data rate R, since a higher source/channel code rate allows for compression with lower quantization errors and hence lower distortion. The rate-distortion characteristics may also be dependent on other application and network layer functionalities, such as frame type (e.g., I-frame, P-frame or B-frame), employed error concealment scheme, network layer packetization and transmission framework used toward passing the compressed source from the codec to the channel encoder (e.g., in RTP/UDP), type of layering in the case of advanced source compression methods such as scalable video coding (SVC) and application-layer forward error correction FEC (e.g., raptor codes, Reed-Solomon codes, etc.).

Furthermore, it is possible to relate end-to-end distortion to the peak SNR (PSNR) metric using the following relation (for a pixel representation with 8 bits per source sample):

$$P S N R = 10 {log}_{10} ( \frac{{255}^{2}}{{D}_{ave}} ) ,$$

indicating that distortion minimization is equivalent to PSNR maximization.

Implementations of the distortion-aware MIMO link adaptation criterion allow for realizing the benefits of joint source-channel coding by adapting the channel coding rate to minimize end-to-end distortion, rather than maximize throughput or spectral efficiency. It should be noted that in order to use this distortion-based MIMO link adaptation criterion, only the distortion-rate function D(b*R) may be available at the radio level (which is determined by the nature of the multimedia source as well as the compression capabilities of the codec or source encoder), so this information can be passed from the application layer to the PHY/MAC (physical/media access control) layer. It should be further noted that the above MIMO link adaptation criterion may be employed in conjunction with any distortion-rate function or any function of rate that quantifies the user's quality of experience for the multimedia application, and that implementations herein also include any method for incorporating distortion criteria or any other criteria that determine multimedia quality in the appropriate selection of a MIMO MCS, precoding matrix, and packet size.

Selection of the MIMO modulation and coding scheme (MIMO-MCS) herein includes (a) selection of the modulation order, (b) selection of the forward error correction (FEC) type and coding rate, and (c) determination of which space-time modulation techniques will be used. Options for space-time modulation include spatial multiplexing (SM), space-time coding (STC), orthogonal space-time block coding (OSTBC), beamforming, etc., including metrics such as STC rate, rank, number of MIMO streams, and the like. Special cases for multi-antenna communications, such as single-input-multiple-output (SIMO) modes can also be used among space-time modulation options. Further, the MIMO link adaptation herein may be employed in conjunction with any distortion-rate function, and implementations may include any method for incorporating distortion criteria in the appropriate selection of a MIMO MCS.

Furthermore, the selection of the precoding matrix Q herein includes (a) beamforming to convert a MIMO channel into an equivalent single-input single-output (SISO) channel, (b) precoded spatial multiplexing, (c) precoded orthogonal space-time block coding (OSTBC), (d) transmit power allocation and covariance optimization, and (e) transmit antenna selection techniques where M out of Mₜ transmit antennas are selected for transmission.

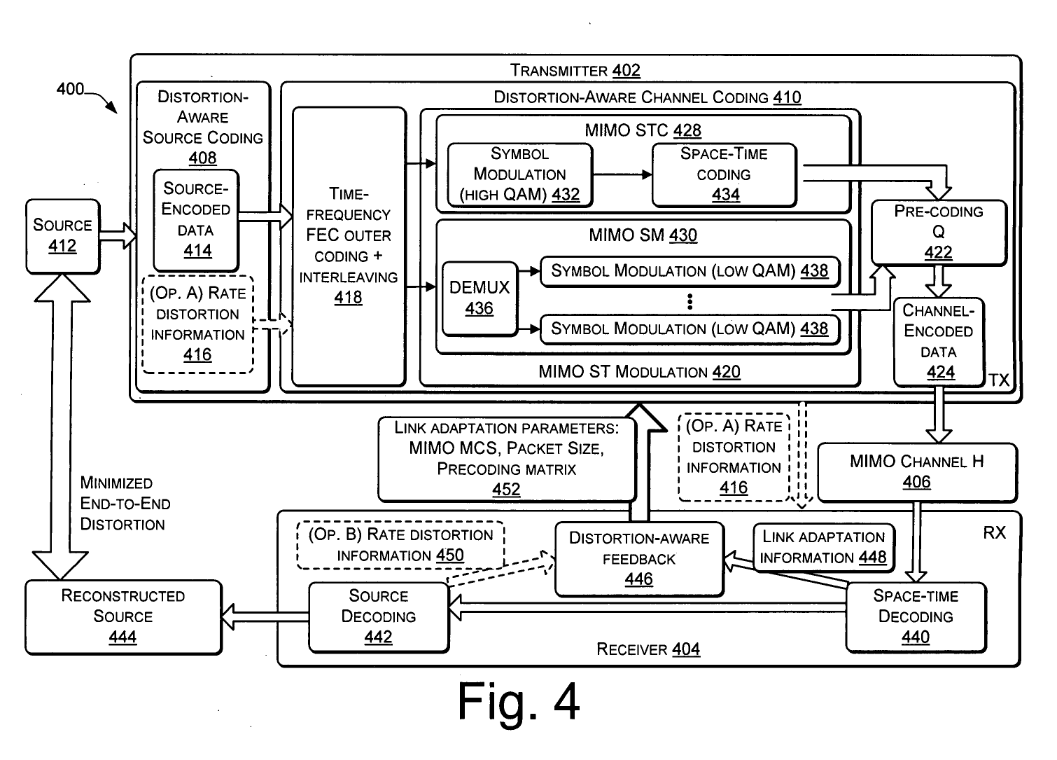

Implementations of the distortion-aware MIMO link adaptation framework are applicable for closed-loop MIMO systems. The resulting system architecture for the transmitter and receiver components is depicted in FIG. 4 for a closed-loop MIMO communication configuration with limited rate feedback of link adaptation parameters. The closed-loop MIMO setup is more relevant for situations where the channel variations occur over a slower time scale (e.g., as in low-mobility scenarios) to allow for reliable channel estimation and feedback of link adaptation parameters from the receiver to the transmitter (i.e., using mechanisms such as the channel quality indicator (CQI) feedback mechanism), creating the opportunity for performing dynamic link adaptation determination at the receiver based on the knowledge of the instantaneous channel conditions, expressed as:

(MIMO_MCS,P_SIZE,Q)=ƒ(SNR,H),

where using the function ƒ, the receiver maps the instantaneous channel realization H and average SNR to a MIMO-MCS scheme, packet size, and a precoding matrix Q, and feeds back the information on these selections to the transmitter. In case of layered video coding, the function ƒ may be modified as follows:

(MIMO_MCS^{(l)},P_SIZE^{(l)}, Q^{(l)})^{L}ₗ₋₁=ƒ^{SVC}(SNR,H)

and hence MIMO MCS, packet size and precoding matrix recommendations are fed back separately for each video layer.

The closed-loop MIMO setup may also be relevant for scenarios in which reliable estimation and feedback of dynamic channel variations and link adaptation parameters is generally difficult (e.g., as in high mobility scenarios), so the distortion-aware MIMO link adaptation can be performed at the transmitter based on the knowledge of the long-term channel variations and statistics of the instantaneous or short-term channel variations. In this context, the closed-loop MIMO link adaptation to minimize end-to-end distortion may also be based on statistical or long-term channel knowledge in communication scenarios where link adaptation parameters are determined by the receiver and fed back to the transmitter, for instance, as in the uplink of cellular communications, and at the same time it is difficult to obtain reliable estimates of the instantaneous or short-term channel conditions for various reasons such as high mobility or high user density. In this setup, the receiver performs link adaptation based on the following rule:

(MIMO_MCS,P_SIZE,Q)=\hat{ƒ}(SNR),

where using the function \hat{ƒ}, the receiver maps the average SNR, that is determined by the knowledge of the long-term channel variations and the statistics of the instantaneous or short-term channel variations, to a MIMO-MCS scheme, packet size, and a precoding matrix Q , and feeds back the information on these selections to the transmitter. In case of layered video coding, the function \hat{ƒ} may be modified as follows:

(MIMO_MCS^{(l)},P_SIZE^{(l)},Q^{(l)})^{L}ₗ₌₁=\hat{ƒ}^{SVC}(SNR)

and hence MIMO MCS, packet size and precoding matrix recommendations are fed back separately for each video layer.

FIG. 4 illustrates a block diagram of an example of a distortion-aware MIMO link adaptation architecture 400 and associated CQI feedback mechanism according to some implementations herein, in which link adaptation parameters are determined at the receiver and are fed back for application at the transmitter. In the architecture of FIG. 4, a transmitter 402 is able to communicate with a receiver 404 via a MIMO channel 406. In the illustrated implementation, transmitter 402 includes a source encoder, shown as distortion-aware source coding block 408, and a channel encoder, shown as distortion-aware channel coding block 410. The distortion-aware source coding block 408 is configured to compress and otherwise encode a source 412, such as a multimedia source at a source coding rate determined by distortion-aware criteria for MIMO MCS selection (which is provided to the distortion-aware channel coding block 410 by feedback from the receiver 404), and pass the source-encoded data 414 along with, in some implementations, rate-distortion information 416 of the source-encoded data 414 to the distortion-aware channel coding block 410. However, in other implementations, it may not be necessary for the source coding block 408 to pass rate distortion information 416 to the channel coding block 410. Instead, as discussed further below, the rate distortion information may be determined directly by the receiver 404 and taken into consideration when preparing feedback that is provided to the distortion-aware channel coding block 410. Hence passing the rate distortion information 416 from the source coding block 408 is used in some implementations of the closed loop architecture, and is labeled as Option A (Op. A) in FIG. 4. Alternatively, or in addition, in other implementations, the rate distortion information may be determined independently at the receiver 404, which is labeled as Option B (Op. B) in FIG. 4, and which is discussed additionally below.

The channel coding block 410 includes a time-frequency forward error correction (FEC) outer coding and interleaving block 418, followed by a MIMO space-time (ST) modulation block 420, which is then followed by a MIMO precoding block 422 to produce channel-encoded data 424, which is sent to receiver 404 over MIMO channel 406 (along with rate-distortion information 416 in the case of Op. A). The MIMO ST modulation block 420 can either operate in the MIMO diversity mode as MIMO STC block 428, or in the MIMO spatial multiplexing mode as MIMO SM block 430. In the MIMO diversity mode, output bits of the channel coding and interleaving block 418 are first modulated by symbol mapping in a symbol modulation block 432 at high QAM, and then re-encoded using a space-time code (STC) into multiple spatial streams at space-time coding block 434. Alternatively, in the MIMO spatial multiplexing mode, the coded/interleaved bits output from the coding and interleaving block 418 are de-multiplexed into multiple spatial streams by a DEMUX block 436 and each stream is then modulated by symbol mapping in a plurality of symbol modulation blocks 438 at low QAM. The decision on what channel coding rate and which type of channel code should be used during FEC outer coding and whether to use the MIMO STC block 428, or the MIMO SM block 430 is dependent upon the determined distortion-aware criteria for MIMO MCS selection, which is provided to the distortion-aware channel coding block 410 by feedback from the receiver 404.

The compressed data is passed through all of these described channel encoding blocks before the multi-antenna transmission. This application considers the case when all of these radio-level channel encoder blocks (corresponding to the BS) may lack the property of “distortion-awareness” since they may not be enabled to execute distortion-aware MIMO link adaptation techniques for MIMO MCS selection, packet size selection and precoding. In contrast, the receiver components 404 (corresponding to the MS) are distortion-aware and are able to determine link adaptation parameters 452 to minimize end-to-end distortion and send them to the BS via the disclosed CQI feedback mechanisms, to be discussed next.

At the receiver 404, a space-time decoding block 440 is configured to recover the transmitted source data from a noisy corrupted received version transmitted over the MIMO wireless channel, following the multi-antenna reception. The recovered data stream is passed to a source decoding block 442, which reconstructs the source with the goal of minimizing the distortion between the original source 412 and a reconstructed source 444.

In order to optimally perform radio resource management and link adaptation in downlink, the BS needs to learn the link qualities to each MS, i.e., toward executing functions such as scheduling and MCS selection. To this end, CQI feedback mechanisms are designed, so that each MS can periodically report its channel state information to the BS. Relevant CQI metrics in this context include physical signal-to-interference-and-noise ratio (SINR) (also known as carrier-to-interference-and-noise ratio (CINR)) and effective SINR (E-SINR or E-CINR), channel state information (e.g., statistical channel information such as channel mean or covariance, transmit/receive correlation matrices, etc., or instantaneous channel information such as channel Demmel condition number) as well as recommendations of the MS for a number of link adaptation modes such as MCS selection, MIMO space-time modulation mode, MIMO STC rate, packet size and precoding matrix index (PMI). One of the methods for transmitting/receiving CQI over the physical layer includes the allocation of a CQI channel (CQICH) by the BS for each MS, so that each MS can report its CQI information using the dedicated CQICH during uplink.

For the closed-loop distortion-aware MIMO link adaptation architecture 400 illustrated in FIG. 4, in order to enable the CQI feedback mechanism in the distortion-aware MIMO link adaptation system architecture, the space-time decoder 440 at the receiving end 404 also includes a distortion-aware feedback design block 446 that periodically provides feedback to transmitter 402 for enabling the distortion awareness of the distortion-aware channel coding block 410, after the distortion-minimizing MIMO link adaptation parameters (i.e., SINR information, statistical or instantaneous channel state information, MIMO MCS, packet size, and precoding matrix Q) have been determined at the receiver 404 based on receiver's knowledge of the average or long-term received SINR and instantaneous or statistical knowledge of the short-term SINR over the MIMO channel. For example, the distortion-aware feedback block 446 at the receiver 404 may determine from the space-time decoding block 440 link adaptation information 448 (i.e., the estimated MIMO channel parameters, and the MIMO MCS, packet size, and precoding matrix Q parameters). The distortion-aware feedback block 446 uses the link adaptation information 448 along with rate distortion information 416 (Op. A) and/or rate distortion information 450 (Op. B) to determine distortion-minimizing link adaptation parameters 452, e.g., a MIMO MCS scheme, packet size and/or precoding matrix Q. For layered video coding, these link adaptation parameters are separately fed back for each layer based on the criteria presented earlier. After the distortion-minimizing MIMO link adaptation parameters 452 have been determined at the receiver 404 based on receiver's knowledge of the long-term channel variations along with the instantaneous or statistical knowledge of short-term MIMO channel realizations, the link adaptation parameters 452 are fed back to the transmitter 402.

In addition, according to some implementations, as discussed above, when determining distortion-minimizing MIMO link adaptation parameters 452, the distortion-aware feedback block 446 may also gather the rate-distortion information 450 about the multimedia source from the source decoding block 442 (Op. B). Alternatively, or in addition, transmitter 402 may send rate-distortion information 416 on the source along with channel-encoded data 424 to receiver 404 over the MIMO channel 406 (Op. A), so that distortion-aware feedback block 446 at receiver 404 may utilize this information in determining distortion-minimizing MIMO link adaptation parameters 452. The rate distortion information 416 and/or 450 are taken into consideration by distortion-aware feedback block 446 when determining the distortion minimizing link adaptation parameters 452, e.g., MIMO MCS, packet size, and/or pre-coding matrix, which are then passed to the transmitter 402 through a feedback channel. For example, transmitter 402 may be incorporated into a first device that also includes a receiver (not shown), while receiver 404 may be in the incorporated into a second device that also includes a transmitter (not shown), thus enabling the receiver 404 to provide feedback wirelessly to the transmitter 402 such as over MIMO channel 406, or other wireless channel, link, or the like.

Implementations herein provide “distortion-awareness” and associated joint source-channel coding ideas to support link adaptation over MIMO systems to enhance multimedia communication. All of the MIMO link adaptation blocks at the transmitter and receiver, including source coding block 408 and channel coding block 410, including MIMO space-time modulation block 420, MIMO precoding block 422, FEC outer coding and interleaving block 418 and feedback block 446 are impacted and operate differently under implementations of the distortion-aware MIMO link adaptation framework herein. Furthermore, implementations herein may provide distortion-aware MIMO link adaptation techniques that are applicable in conjunction with any of unicast (i.e., one streaming connection established per user), broadcast (i.e., one streaming connection established per service content) and multicast transmission techniques (i.e., one streaming connection established per a selected group of users).

One example of an application according to some implementations of the distortion-aware MIMO link adaptation techniques in this context may be multicast broadcast services (MBS) in the WiMAX 802.16 standard discussed above, also known as multimedia broadcast and multicast services (MBMS) in the standards developed by the Third Generation Partnership Project (3GPP) and BroadCast and MultiCast Service (BCMCS) in standards developed by 3GPP2 (Third Generation Partnership Project 2). For instance, in the context of MBS, conventional link adaptation approaches that aim to maximize goodput typically determine the multimedia transmission rate so that a certain percentage (e.g., 95%) of the users in the network can reliably (e.g., with PER at 1% or lower) receive the multimedia transmission. However, according to some implementations herein, the distortion-aware link adaptation protocols can instead determine the multimedia transmission rate and the associated level of multimedia reception quality (measured in terms of PSNR or average end-to-end distortion) so that a certain percentage (e.g., 95%) of the users in the network can be guaranteed multimedia service with a particular quality of experience (i.e., PSNR or average end-to-end distortion below a predetermined threshold).

The disclosed CQI feedback mechanism to enable distortion-awareness accommodates various forms of the link adaptation: 1) use of long-term vs. dynamic link adaptation techniques; 2) choice between MS-Controlled vs. BS-controlled link adaptation; and/or 3) presence or lack of distortion-awareness at BS. These three forms of link adaption will now be discussed in turn.

Long-Term Link Adaptation: For situations in which reliable feedback of dynamic channel variations and link adaptation parameters is generally difficult (e.g., as in high mobility or high user density scenarios), the distortion-aware MIMO link adaptation can be performed based only on the knowledge of the long-term channel variations, and statistics of the instantaneous or short-term channel variations. In this setup, the long-term link adaptation is performed based on the following rule:

(MIMO_MCS,P_SIZE,Q)=ƒ(SINR),

where the distortion-aware MIMO link adaptation function ƒ maps the average or long-term SINR, that is determined by the knowledge of the long-term channel variations and the statistics of the instantaneous or short-term channel variations, to a MIMO-MCS scheme, a packet size, and a precoding matrix Q. In case of layered video coding, the function ƒ may be modified as follows:

(MIMO_MCS^{(l)},P_SIZE^{(l)},Q^{(l)})^{L}ₗ₌₁=ƒ^{SVC}(SINR)

and hence MIMO MCS, packet size and precoding matrix recommendations are fed back separately for each video layer.

Dynamic Link Adaptation: For situations where the channel variations occur over a slower time scale (e.g., as in low-mobility scenarios) to allow for reliable estimation and feedback of both long-term and short-term channel variations and link adaptation parameters, the distortion-aware MIMO link adaptation can be performed based on the knowledge of the instantaneous channel conditions, expressed as:

(MIMO_MCS,P_SIZE,Q)=\hat{ƒ}(SINR,H),

where the distortion-aware MIMO link adaptation function \hat{ƒ} maps the instantaneous or short-term MIMO channel realization H and average or long-term SINR to a MIMO-MCS scheme, a packet size, and a precoding matrix Q. In case of layered video coding, the function \hat{ƒ} may be modified as follows:

(MIMO_MCS^{(l)},P_SIZE^{(l)},Q^{(l)})^{L}ₗ₌₁=\hat{ƒ}^{SVC}(SINR,H)

and hence MIMO MCS, packet size and precoding matrix recommendations are fed back separately for each video layer.

MS-controlled: If the link adaptation is MS-controlled, BS may follow the recommendations of the MS in terms of link adaptation modes, such as MCS selection, MIMO space-time modulation mode, packet size selection, and/or PMI.

BS controlled: On the other hand, if the link adaptation is BS controlled, then BS will receive SINR information, MIMO channel information and link adaptation mode recommendations of the MS over the CQI feedback mechanism, and then the BS will consider this CQI but will not necessarily follow the recommendations of the MS in determining the link adaptation modes.

Both MS-controlled and BS-controlled link adaption modes have advantages and disadvantages, for instance the advantage of the MS-controlled link adaptation is that MS has the best knowledge of interference and channel information, mobility/dynamics, and especially of specific modem performance allowing for suitable MCS selections. In the meantime, the advantage of the BS-controlled link adaptation is that the BS has the system information such as scheduling tradeoffs, QoS, delay, interference, etc. to optimize MCS for each packet length, delay from CQI and HARQ parameters.

Distortion-Awareness at the BS: In the case of MS-controlled link adaptation, distortion-awareness at the BS is not necessary for distortion-aware link adaptation, and distortion-awareness at the MS terminal is sufficient to ensure optimal link adaptation from the standpoint of minimizing end-to-end distortion, because link adaptation parameters selected by the BS are identical to those determined and fed back by the MS terminal based on distortion-aware MIMO MCS, precoding matrix and/or packet size selection criteria.

In the case of BS-controlled link adaptation, distortion-aware link adaptation is not guaranteed, since BS may not be distortion-aware and may override the MIMO MCS, precoding matrix and packet size recommendations of the MS with its own MIMO MCS, precoding matrix and packet size selections, which may potentially yield higher goodput or spectral efficiency, but are suboptimal from the standpoint of minimizing end-to-end distortion. For instance, looking at the SINR reported by the MS, the BS may follow a goodput-maximizing link adaptation strategy and assign a higher MCS than that would be selected under a distortion-minimizing link adaptation strategy, and this would result in an increase in the PER and end-to-end distortion for multimedia content delivery leading to poorer user experience.

Non-Distortion-Awareness at the BS: To remedy this end-to-end distortion issue due to the BS not being distortion-aware, this application discloses a methodology to determine the CQI feedback parameters so that the subsequent MIMO MCS, precoding matrix and packet size selections by a BS that is not distortion-aware may match those obtained under the distortion-aware link adaptation criteria. In other words, after having determined the MIMO MCS, precoding and packet size selections using its distortion-aware link adaptation criteria, the MS designs all of the CQI feedback parameters such as SINR, effective SINR, etc., so that the same distortion-minimizing MIMO MCS, precoding matrix and packet size selections can be obtained by the BS after the execution of the distortion-suboptimal (e.g., goodput-maximizing) link adaptation algorithm used by the BS. Such a scheme involves both the recognition by the MS that the BS is not distortion-aware, and the knowledge/learning at the MS terminal of the link adaptation criteria that is used by the BS.

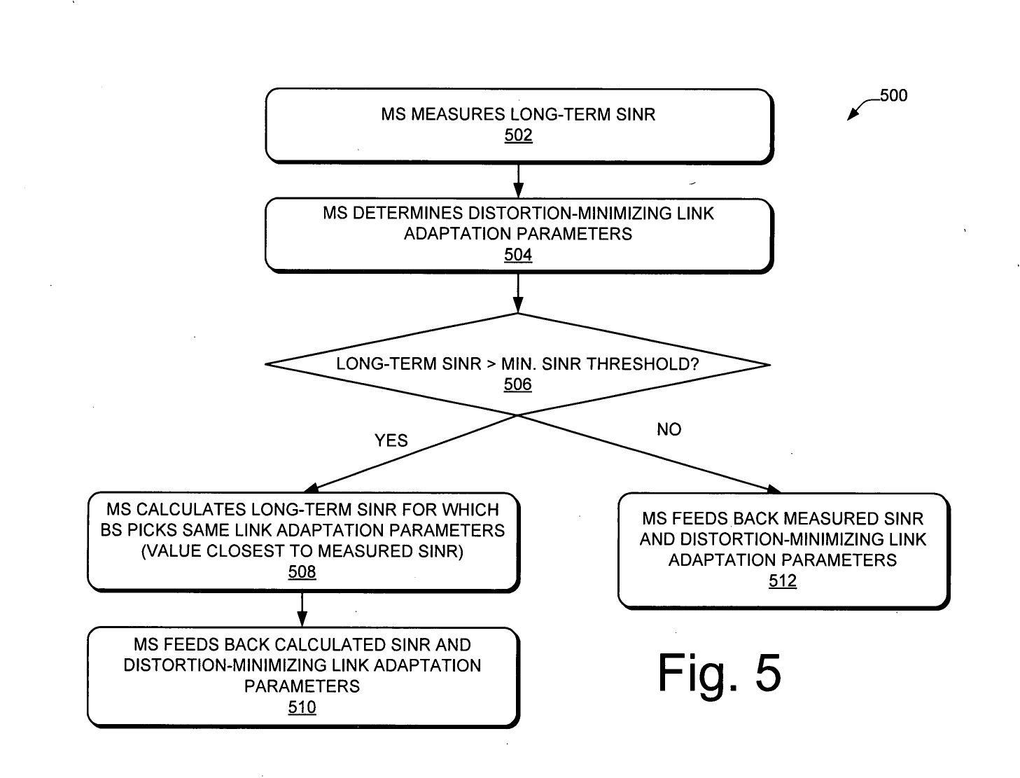

FIG. 5 illustrates a flow diagram of an exemplary process 500 for a CQI feedback mechanism for distortion-aware communications in the case of BS-controlled, long-term adaption with no distortion-awareness at the BS. The determination of the long-term SINR feedback metric at the MS as a part of the CQI feedback mechanism (for long-term link adaptation) can be performed based on the following process. The BS and MS may perform long-term link adaptation based on the following look-up tables or functions that map long-term SINR values to MIMO MCS, packet size and precoding matrix selections (in case of layered video coding, different layers would be assigned different MIMO MCS, packet size and precoding matrix selections):

Link adaptation criterion at the MS (distortion-minimizing):

(MIMO_MCS,P_SIZE,Q)_{MS}=ƒ_{MS}(SINR)

Link adaptation criterion at the BS (e.g., goodput-maximizing):

(MIMO_MCS,P_SIZE,Q)_{BS}=\hat{ζ}_{BS}(SINR)

It may be assumed that the link adaptation criterion employed by the BS, i.e., defined by function ζ_{BS}, is known at the MS terminal.

In act 502, MS measures its long-term SINR. This value may be denoted as SINR_{measured}.

In act 504, MS looks up the link adaptation parameters, i.e., MIMO MCS, packet size and precoding matrix selections, that minimize distortion at this SINR value of SINR_{measured}. These link adaptation parameters may be denoted as (notation includes different MIMO MCS, packet size and precoding matrix selections for layered video coding):

(MIMO_MCSₒₚₜᵢₘₐₗ,P_SIZEₒₚₜᵢₘₐₗ, Qₒₚₜᵢₘₐₗ)=ƒ_{MS}(SINR_{measured}).

For certain embodiments of the disclosed SINR feedback mechanism, the MS may employ a minimum SINR threshold requirement SINRₘᵢₙ such that it feeds back the actual long-term SINR measurement SINR_{measured} to the BS if the measured SINR value is below that threshold, i.e., if SINR_{measured}<SINRₘᵢₙ [act 506]. The disclosed SINR feedback mechanism is only used when SINR_{measured} exceeds the threshold SINR value, i.e., when SINR_{measured}>SINRₘᵢₙ. The minimum SINR threshold requirement aims to ensure that the lower SINR reporting by the MS does not have a negative impact on other network operations between the MS and BS that may rely on the feedback of SINR measurements, such as handover, quality of service (QoS) management, service admission, etc., when the MS already experiences low SINR conditions. Because the major gains of distortion-aware link adaptation over goodput-maximizing link adaptation are observed primarily in the higher SINR ranges, the use of such a minimum SINR threshold also does not reduce the optimality of CQI feedback in terms minimizing end-to-end distortion.

Since MS also knows the goodput-maximizing look-up table for the link adaptation parameters, i.e., MIMO MCS, packet size and precoding matrix selections, that the BS is using for link adaptation, i.e., given by the function ƒ_{BS}, it can also determine which long-term SINR value would result in the choice of the same MIMO MCS, packet size and precoding matrix selections according to goodput-maximizing link adaptation [act 508]. In other words, from the set of SINR values that satisfy

(MIMO_MCSₒₚₜᵢₘₐₗ,P_SIZEₒₚₜᵢₘₐₗ,Qₒₚₜᵢₘₐₗ)=ƒ_{BS}(SINR),

in act 508 the MS picks the SINR such that

$${SINR}_{feedback} = arg {min}_{SINR} \vert SINR - {SINR}_{measured} \vert .$$

If no such SINR value is found, the search is relaxed so that other precoding matrices are considered and MS searches for the set of SINR values that satisfy

(MIMO_MCSₒₚₜᵢₘₐₗ,P_SIZEₒₚₜᵢₘₐₗ,Qₒₜₕₑᵣ)=ƒ_{BS}(SINR),

in act 508 the MS picks the SINR such that

$${SINR}_{feedback} = arg {min}_{SINR} \vert SINR - {SINR}_{measured} \vert .$$

If no such SINR value is found, the search is further relaxed so that other precoding matrices and packet sizes are considered and MS searches for the set of SINR values that satisfy

(MIMO_MCSₒₚₜᵢₘₐ,P_SIZEₒₜₕₑᵣ,Qₒₜₕₑᵣ)=ƒ_{BS}(SINR),

in act 508 the MS picks the SINR such that

$${SINR}_{feedback} = arg {min}_{SINR} \vert SINR - {SINR}_{measured} \vert .$$

If no such SINR value is found, MS feeds back SINR_{measured}.

In act 510 MS feeds back SINR_{feedback} (or the index of the quantized SINR value that is closest to SINR_{feedback}) instead of the actual long-term SINR measurement SINR_{measured} to the BS, so that the BS assigns the distortion-minimizing MIMO MCS selection MIMO_MCSₒₚₜᵢₘₐₗ, possibly along with packet size selection P_SIZE ₒₚₜᵢₘₐₗ and precoding matrix selection Qₒₚₜᵢₘₐₗ to its link after executing its link adaptation framework based on the link adaptation parameter look-up table defined by the function ƒ_{BS}.

In act 512, when SINR_{measured}<SINRₘᵢₙ the MS feeds back SINR_{measured} and distortion-minimizing link adaptation parameters, including MIMO MCS, packet size and precoding matrix selections. Although not explicitly shown, after act 512, the BS assigns these MIMO MCS, packet size and precoding matrix selections to its link after executing its link adaptation framework based on the feedback and link adaptation parameter look-up table defined by the function ƒ_{BS}.

The resulting logic flow diagram for the disclosed SINR-based CQI feedback process for long-term link adaptation is depicted in FIG. 5. It should be noted that the same process may also be used for determining feedback metrics on long-term MIMO channel information to be used by the BS for long-term link adaptation.

A similar CQI feedback design process is also applicable for dynamic link adaptation in which the dynamic SINR and short-term MIMO channel information may be determined and fed back by the MS to the BS in order to ensure distortion-aware link adaptation toward the selection of MIMO MCS, packet size and precoding matrix. Such similar process would be mostly the same at process 500, except that long-term SINR in acts 502, 506, and 508 may be replaced with a dynamic or short-term SINR or other instantaneous channel parameter(s) (e.g., channel rank, etc.).

As discussed thus far, the design of the CQI feedback mechanism and CQI feedback metrics to support distortion-aware MIMO link adaptation depends on three factors: 1) use of long-term vs. dynamic link adaptation techniques; 2) choice between MS-Controlled vs. BS-controlled link adaptation; and 3) presence or lack of distortion-awareness at BS. The various permutations of these three factors may produce eight possible, distinct modes of operation.

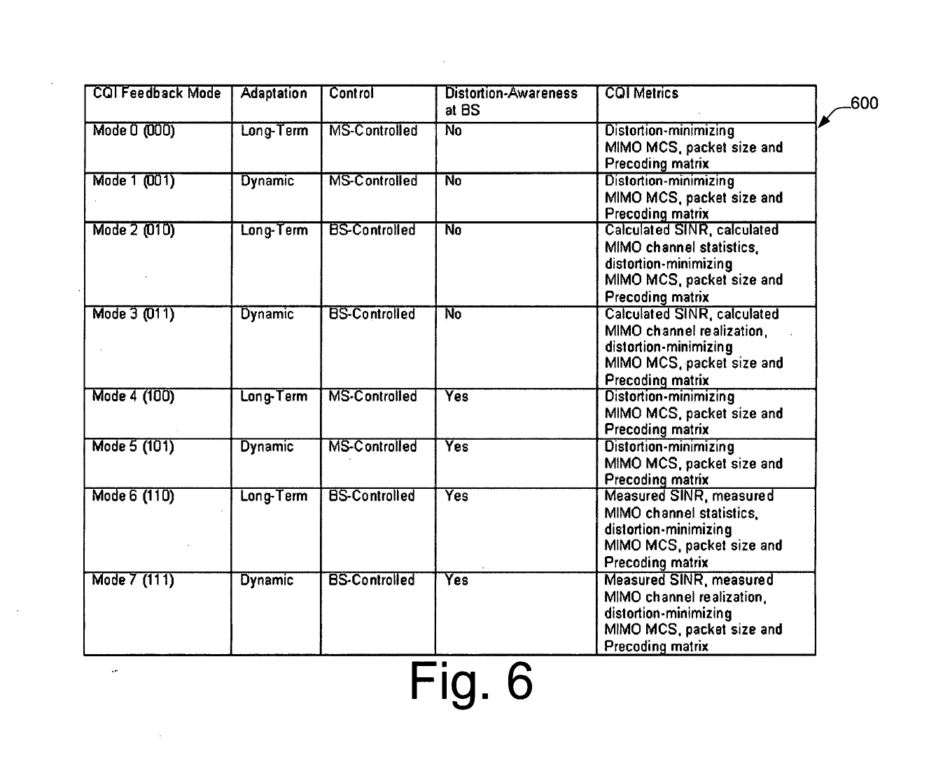

FIG. 6 illustrates a table of CQI feedback modes and CQI metrics for distortion-aware MIMO link adaptation according to some implementations. As summarized below and in Table 600 in FIG. 6, this leads to a total of eight new CQI feedback modes, with the corresponding CQI feedback metrics to support distortion-aware MIMO link adaptation. The corresponding set of MIMO MCS, packet size and precoding modes are presented below after the description of the eight possible modes.

CQI Feedback Modes 0 and 4: If the long-term link adaptation is performed at the receiver (MS-controlled), then the information on these selections (i.e., MIMO MCS, packet size and precoding matrix selections for one or more video layers) may be fed back to the transmitter (the BS) using the disclosed CQI feedback mechanisms. In this setting, distortion-awareness at the BS is not needed for distortion-aware link adaptation.

CQI Feedback Modes 1 and 5: If the dynamic link adaptation is performed at the receiver (MS-controlled), then the information on these selections (i.e., MIMO MCS, packet size and precoding matrix selections for one or more video layers) may be fed back to the transmitter (the BS) using the disclosed CQI feedback mechanisms. In this setting, distortion-awareness at the BS is not needed for distortion-aware link adaptation.

CQI Feedback Modes 2 and 6: If the long-term link adaptation and MCS is performed at the transmitter (BS-controlled), then the disclosed CQI feedback mechanisms can be used to inform the transmitter (the BS) about the channel information, i.e., long-term SINR and short-term channel statistics (e.g., MIMO channel correlation matrix) and receiver's (MS's) recommendations on MIMO MCS, packet size and precoding matrix selections for one or more video layers. If the BS is distortion-aware, the measured channel information is fed back by the MS (Mode 6), while for the case in which the BS is not distortion-aware, the calculated channel information is fed back by the MS (Mode 2), per the guidelines described in FIG. 5.

CQI Feedback Modes 3 and 7: If the dynamic link adaptation is performed at the transmitter (BS-controlled), then the disclosed CQI feedback mechanisms can be used to inform the transmitter (the BS) about the channel information, i.e., long-term SINR and short-term or instantaneous MIMO channel realizations and receiver's (MS's) recommendations on MIMO MCS, packet size and precoding matrix selections for one or more video layers. If the BS is distortion-aware, the measured channel information is fed back by the MS (Mode 7), while for the case in which the BS is not distortion-aware, the calculated channel information is fed back by the MS (Mode 3).

Although described above in a broad manner (e.g., MCS), such modulation and coding schemes consistent with the disclosed invention are varied, and several specific schemes may be employed. For example, the set of MIMO link adaptation parameters and the associated selection of the MIMO modulation-and-coding schemes (MIMO-MCS) may include: i) selection of the modulation order; ii) selection of the FEC type and coding rate; iii) determination of which space-time modulation techniques will be used, options include spatial multiplexing (SM), space-time coding (STC), orthogonal space-time block coding (OSTBC), beamforming, etc., including metrics such as STC rate, rank, number of MIMO streams, etc. Special cases for multi-antenna communications such as single-input single-output (SISO), multiple-input single-output (MISO) and single-input multiple-output (SIMO) modes can also be used among space-time modulation options; and/or iv) precoding matrix index (PMI)

Similarly, the selection of the precoding matrix Q, as broadly described above, may include in various implementations: i) beamforming to convert a MIMO channel into an equivalent single-input single-output (SISO) channel; ii) precoded spatial multiplexing; iii) precoded orthogonal space-time block coding (OSTBCs); iv) transmit power allocation and covariance optimization; and/or v) transmit antenna selection techniques where out of transmit antennas are selected for transmission.

It should be further noted that the above CQI feedback design criteria may be employed in conjunction with any distortion-rate function, and that implementations herein also include any method for incorporating distortion criteria in the appropriate selection of link adaptation parameters. In addition, implementations herein also encompass all link adaptation, precoding and CQI feedback techniques toward optimizing objective distortion metrics such as peak SNR (PSNR) and subjective distortion metrics that account for human visual perception and more precisely quantify user's perceived multimedia quality of experience (QoE), such as video quality metrics (VQM), structural similarity metrics (SSIM) and perceptual evaluation of video quality (PEVQ) metrics. Hence, this scope of this invention and associated rate-distortion characteristics under consideration for MIMO link adaptation, precoding and CQI feedback are based on the broader definition of distortion to cover all objective and subjective multimedia quality metrics, tracked and specified for different source and channel coding rates. Moreover, overall multimedia distortion may be a function of PSNR, error-rate performance, and could be codec dependent and packet dependent (e.g., I-frames, P-frames, B-frames, etc.), including specific cost impacts of errors on specific types of compressed packets.

This application describes new channel quality indicator (CQI) feedback mechanisms to support distortion-aware link adaptation techniques disclosed in the related application referenced above in paragraph [0001], toward enhanced multimedia communications, with the goal of optimizing end-to-end robustness of multimedia content (e.g., mobile video) delivery in order to enable the best user experience. In this context, minimizing end-to-end distortion may be a the new objective for MIMO system design, which differs from classical approaches that aimed for other optimizations, such as maximizing spectral efficiency and goodput, or minimizing packet loss probability. This leads to new “distortion-aware” link adaptation guidelines for selecting adaptive modulation and coding (AMC), MIMO space-time modulation, rate/power adaptation, precoding, packet size and antenna selection modes and parameters, subject end-to-end distortion minimization criteria. The CQI feedback mechanisms described in this application ensure that these distortion-aware MIMO link adaptation techniques are applicable for downlink, under different forms of link adaptation, including MS-controlled vs. BS-controlled link adaptation and long-term vs. dynamic link adaptation.

While the distortion-aware link adaptation concepts may be beneficial toward enhanced multimedia communications, their full benefits may not be realizable without enabling the property of “distortion-awareness” at the client devices and network infrastructure components. In current wireless networks, however, the network infrastructure components, including the base-stations and radio network controllers, typically are not expected to possess distortion-aware processing capabilities. A key question in this context becomes whether the benefits of distortion-aware link adaptation may still be realized in this setting. Thus, in addition to the specification of CQI feedback mechanisms to support distortion-aware link adaptation, another aim herein is to address the practically-relevant case in which the base stations (BS) and other network infrastructure components lack the property of distortion-awareness, i.e., they may be designed to perform link adaptation to maximize goodput, while the mobile station (MS) terminals are able to determine link adaptation parameters in a distortion-aware fashion. In this setting, several novel mechanisms for CQI feedback have been disclosed to allow the MS to influence and/or guide the link adaptation decisions of the BS, so that end-to-end distortion can be minimized over the BS-MS link for enhanced multimedia delivery and user experience.

Thus the scheme herein introduces the notion of “distortion-awareness” and associated joint source-channel coding ideas to support link adaptation over MIMO systems, leading to novel system architectures for MIMO systems. The CQI feedback mechanisms disclosed herein ensure that these distortion-aware MIMO link adaptation techniques are applicable for downlink, under different forms of link adaptation, including MS-controlled vs. BS-controlled link adaptation, long-term vs. dynamic link adaptation, and presence vs. absence of distortion-awareness at the BS.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the invention. For example, any or all of the acts in FIG. 5 or similar described processes may be performed as a result of execution by a computer (or processor or dedicated logic) of instructions embodied on a computer-readable medium, such as a memory, disk, etc.

No element, act, or instruction used in the description of the present application should be construed as critical or essential to the invention unless explicitly described as such. Also, as used herein, the article “a” is intended to include one or more items. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. A method comprising:
measuring a measured channel parameter by a mobile station;
determining a determined modulating and coding scheme, packet size or precoding matrix for one or more multimedia layers that minimizes distortion of data received over a MIMO channel;
calculating one or more calculated channel parameters with which a base station would produce the determined modulating and coding scheme, packet size or precoding matrix for one or more multimedia layers; and
feeding back the one or more calculated channel parameters to the base station.

2. The method according to claim 1, wherein the measured channel parameter is a long-term signal-to-interference-and-noise ratio (SINR).

3. The method according to claim 1, wherein the measured channel parameter is a dynamic or short-term signal-to-interference-and-nose ratio (SINR).

4. The method according to claim 1, wherein the determining determines the modulation and coding scheme for one or more multimedia layers based on the measured channel parameter.

5. The method according to claim 1, wherein determining of the modulation and coding scheme includes:
selecting a modulation order;
selecting a forward error correction type and coding rate; or
determining space-time modulation techniques to be used.

6. The method according to claim 1, wherein the feeding back includes:
feeding back parameters corresponding to the determined modulating and coding scheme or parameters corresponding to a precoding matrix or a packet size, for one or more multimedia layers.

7. The method according to claim 1, further comprising:
comparing the measured channel parameter with a threshold,
wherein the calculating and feeding back are performed if the measured channel parameter is greater than the threshold.

8. The method according to claim 7, further comprising:
feeding back the measured channel parameter to the base station if the measured channel parameter is less than the threshold.

9. Processor-readable storage media containing processor-executable instructions for execution by a processor for carrying out the method according to claim 1.

10. A method comprising:
measuring a first signal-to-interference-and-noise ratio (SINR) by a distortion-aware mobile station;
determining first distortion-minimizing link adaptation parameters for use by a base station that minimize distortion of one or more multimedia layers received over a multiple-input, multiple-output (MIMO) channel based on the first SINR; and
transmitting a second SINR and second link adaptation parameters to the base station that cause the base station to transmit source data to the mobile station over the MIMO channel using the first distortion-minimizing link adaptation parameters.

11. The method according to claim 10, wherein the first SINR and the second SINR are both long-term SINRs.

12. The method according to claim 10, wherein the first SINR and the second SINR are both dynamic or short-term SINRs.

13. The method according to claim 10, wherein the base station is also distortion-aware, and
wherein the second SINR equals the first SINR and the second link adaptation parameters are identical to the first distortion-minimizing link adaptation parameters.

14. The method according to claim 10, wherein the base station is not distortion-aware, and
wherein the second SINR is different from the first SINR.

15. The method according to claim 14, further comprising:
calculating the second SINR so that the base station will choose first distortion-minimizing link adaptation parameters upon receiving the second SINR and second link adaptation parameters.

16. The method according to claim 10, further comprising:
comparing the first SINR with a minimum SINR threshold; and
calculating the second SINR so that the base station will choose first distortion-minimizing link adaptation parameters upon receiving the second SINR if the first SINR is greater than the minimum SINR threshold.

17. The method according to claim 16, wherein the second SINR in the transmitting equals the first SINR if the first SINR is less than the minimum SINR threshold.

18. Processor-readable storage media containing processor-executable instructions for execution by a processor for carrying out the method according to claim 10.

19. A station comprising:
a receiver having a processor for implementing a source decoder for decoding a source subject to the knowledge of application-layer information after transmission over a multiple input multiple output (MIMO) channel;
a distortion-aware feedback module for generating a link adaptation parameter set including a MIMO modulation and coding scheme (MCS), packet size and precoding information for one or more multimedia layers selected to minimize distortion of the source due to transmission over the MIMO channel, subject to the knowledge of the application layer information; and
a transmitter to transmit the MIMO MCS, packet size and the precoding information for one or more multimedia layers to an upstream station for the upstream station's use in encoding the source for downstream transmission over the MIMO channel.

20. The station according to claim 19, wherein the distortion-aware feedback module is configured to select the MIMO MCS, packet size and precoding information for one or more multimedia layers to minimize distortion based upon an instantaneously determined channel condition or a statistically known channel condition.

21. The station according to claim 19, wherein the application-layer information is the rate-distortion information for the source and source decoder is arranged to provide rate distortion information to the distortion-aware feedback module for generating the MIMO MCS, packet size and precoding information. for one or more multimedia layers.

22. The station according to claim 19, wherein the source encoder is arranged to communicate application-layer information which may include rate distortion information of the source to the distortion-aware feedback module for generating the MIMO MCS, packet size and precoding information. for one or more multimedia layers.

23. The station according to claim 19,
wherein the distortion-aware feedback module is further configured to calculate a channel parameter which, when transmitted to the upstream station, will cause the upstream station to produce generated MIMO MCS, packet size and precoding matrix for one or more multimedia layers to encode the source to minimize distortion of the source due to transmission over the MIMO channel subject to the knowledge of application layer information.
